(19) United States
(12) Patent Application Publication
(10) Pub. No.: US 2012/0222904 A1
(43) Pub. Date: Sep. 6, 2012

(54) CASE HANDLE WITH WEIGHING DISPLAY

(75) Inventor: Huibao LU, SHENZHEN CITY (CN)

(73) Assignee: TALENTECH PLASTIC (SHENZHEN) LIMITED, SHENZHEN CITY (CN)

(21) Appl. No.: 13/039,265

(22) Filed: Mar. 2, 2011

(51) Int. Cl. G01G 19/58

(52) U.S. Cl. 177/148

(57) ABSTRACT

The present invention relates to a case candle, particularly relates to a case candle with weighing display, which includes a handle seat and a connection that is connected between the handle seat and case body, which is characterized in that, the handle seat has a manganese steel sheet inside, a bend sensor is fixed at the top of the manganese steel sheet, the bend sensor is connected to a PCB board, the PCB board is connected to battery and display respectively. The present invention with the above-mentioned structure, when the case is pulled, the manganese steel sheet makes blending deformation under force, the blend sensor permanently connected with the manganese steel sheet induces the deformation, and accurately measures the weight of the case body through pre-set parameters and calculate method, has advantages such as accurate weighing, long life and so on.

### BACKGROUND OF THE INVENTION

The present invention relates to a case candle, particularly relates to a case candle with weighing display.

At present, there have been suitcases or packages with weighing function. Such as the Chinese patent ZL200620044154.1 “a suitcase with electronic scale”, which disclosed a suitcase that set the host of electronic scale on the top side of the of the case body and set the sensors connected with the host of the electronic scale in the four feet of the underside of the case body. The weighing suitcase with this structure can display the weight of the case at any time. Even if you don't need to know the weight, the sensors set in the four feet of the case body are in the state of weight-bearing. This situation can cause fatigue damage to the sensors, thereby cause the accuracy of weighing down, even lose the function of weighing. Strictly speaking, this weighing sensor can not work under a long-time impact of irregular external force, usually the effective weighing data only be obtained by weighing operation under the environmental condition suitable for weighing. Therefore, the weighing suitcases with this structure have defects such as poor weighing accuracy, short life and so on.

### BRIEF SUMMARY OF THE INVENTION

The technical problem that the present invention to solve is to make up the defects of the prior art, and the present invention provides a case handle with weighing display which has simple structure, high weighing accuracy and long life.

The present invention takes the following embodiments to achieve this purpose, a case handle with weighing display, includes a handle seat and a connection that is connected between the handle seat and case body, the handle seat has a manganese steel sheet inside, a bend sensor is fixed at the top of the manganese steel sheet, the bend sensor is connected to a PCB board, the PCB board is connected to battery and display respectively.

The embodiment of the present invention further includes, the handle seat has a cavity in the upper part, and has a upper cover above it, the upper cover encapsulates the manganese steel sheet, bend sensor, PCB board, battery and display in the cavity of the upper part of the handle seat.

The connection is in the cavity of the handle seat, the both ends of the connection bents down through the handle seat to connect with the case body.

The manganese steel sheet has a top holder in the lower part.

The handle seat has a lower cover in the lower part, the handle seat, lower cover and top holder have corresponding thread-holes, the screws fixes the lower cover and top holder to the handle seat.

The display is fixed in the display protecting frame.

The display is LCD display.

The upper cover has a hole in the center, and the display protecting frame is fixed in the hole.

The both ends of the connection have thread-holes, the both ends of the manganese steel sheet have corresponding thread-holes, the screws make the connection and the manganese steel sheet permanently connect.

The blend sensor is fixed between the connection and the manganese steel sheet.

The both ends of the manganese steel sheet are connected with shrapnel respectively, the connection is fixed in the end of shrapnel.

The display is fixed in the display protecting frame.

The upper surface of the display fixes a display protecting cover.

The display is LCD display.

The lower part of the display protecting frame is open, and has a hole in the upper surface, the lower cover encapsulates the manganese steel sheet, bend sensor, PCB board and display in the lower part of the display protecting frame, and the display protecting cover is through out the hole.

The lower cover is a plastic soft cover, and fixes a top holder in the upper surface.

The connection is connected with the case body through the both ends of the handle seat.

The upper and lower ends of the connection fix a handle cover.

The present invention with the above-mentioned structure, when the case is pulled, the manganese steel sheet makes blending deformation under force, the blend sensor permanently connected with the manganese steel sheet induces the deformation, and accurately measures the weight of the case body through pre-set parameters and calculate method, has advantages such as accurate weighing, long life and so on.

### BRIEF DESCRIPTION OF THE DRAWINGS

FIG. 1 is the structural exploded view of example 1 of the present invention.

FIG. 2 is the overall structural diagram of example 1 of the present invention.

FIG. 3 is the structural exploded view of the weighing device in example 2 of the present invention.

FIG. 4 is the structural assembly view of the weighing device in example 2 of the present invention.

FIG. 5 is the structural diagram of the handle seat in example 2 of the present invention.

FIG. 6 is the structural assembly view of example 2 of the present invention.

FIG. 7 is overall structural diagram of example 2 of the present invention.

In the figure, 1. upper cover, 2. handle seat, 3. lower cover, 4. connection, 5. display protecting frame, 6. display, 7. PCB board, 8. manganese steel sheet, 9. blend sensor, 10. top holder, 11. hole, 12. screw, 13. screw, 14. battery;

2′. handle seat, 4′. connection, 5′. display protecting frame, 6′. display, 7′. PCB board, 8′. manganese steel sheet, 9′. blend sensor, 10′. top holder, 11′. hole, 14′. battery, 15. display protecting cover, 16. shrapnel, 17. lower cover, 18. handle cover, 19. hole.

### DETAILED DESCRIPTION OF THE INVENTION

Thereafter the present invention will be described in detail combining the drawings and examples.

The present invention takes installing in the handle of draw-bar case as implementation of structure one.

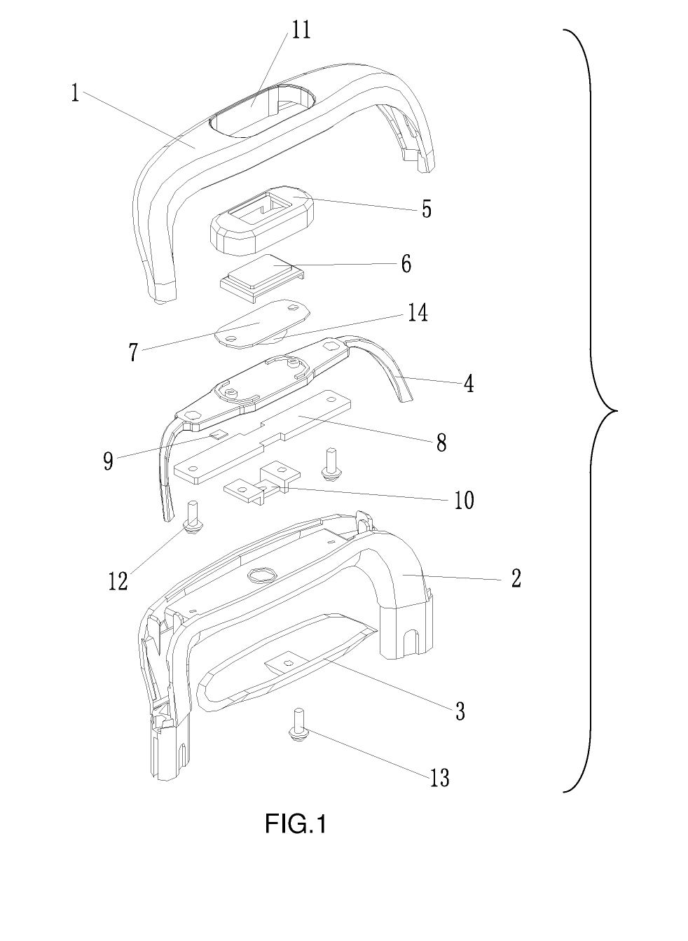

As shown in FIG. 1, the present invention includes handle seat 2 and connection 4 that is connected between handle seat 2 and case body, the handle seat 2 has a cavity in the upper part, and has a upper cover 1 above it. The upper cover 1 has a hole 11 in the center, the display 6 is fixed in the display protecting frame 5, and the display protecting frame 5 is fixed in the hole 11. The display 6 is LCD display.

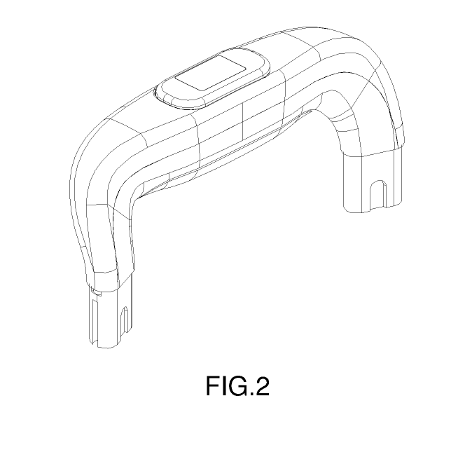

The connection 4 is in the cavity of the handle seat 2, the both ends of the connection 4 bents down through the handle seat 2 to connect with the case body. The PCB board 7 is fixed on the top side of connection 4, and connects with battery 14 and display 6 respectively, meanwhile, the PCB board 7 connects to the blend sensor 9 under the connection 4. The both ends of the connection 4 have thread-holes, the both ends of the manganese steel sheet 8 have corresponding thread-holes, the screws 12 make the connection 4 and the manganese steel sheet 8 permanently connect. The blend sensor 9 is fixed between the connection 4 and the manganese steel sheet 8. The manganese steel sheet 8 has a top holder 10 in the lower part, the both ends of the top holder 10 is close to the manganese steel sheet 8, its center depresses and has thread-holes, the handle seat 2 and lower cover 3 have corresponding thread-holes, the screws 13 fixes the lower cover 3 and top holder 10 to the handle seat 2. The upper cover 1 encapsulates the manganese steel sheet 8, bend sensor 9, PCB board 7, battery 14 and display 6 in the cavity of the upper part of the handle seat 2, its overall package structural diagram is shown in FIG. 2.

When hold the handle seat 2, a upward pressure will be caused to lower cover 3, which then be transferred from lower cover 3 to the manganese steel sheet 8 through the top holder 10, the manganese steel sheet 8 blends under force, the blend sensor 9 connected with the manganese steel sheet 8 induces the deformation, and transfers the result to PCB board, the PCB board 7 accurately measures the weight of the case body through pre-set parameters and calculate method, and displays on the display 6 in the surface of upper cover 1, the user can easily know the weight of the case body.

The present invention takes installing in the soft handle as implementation of structure two.

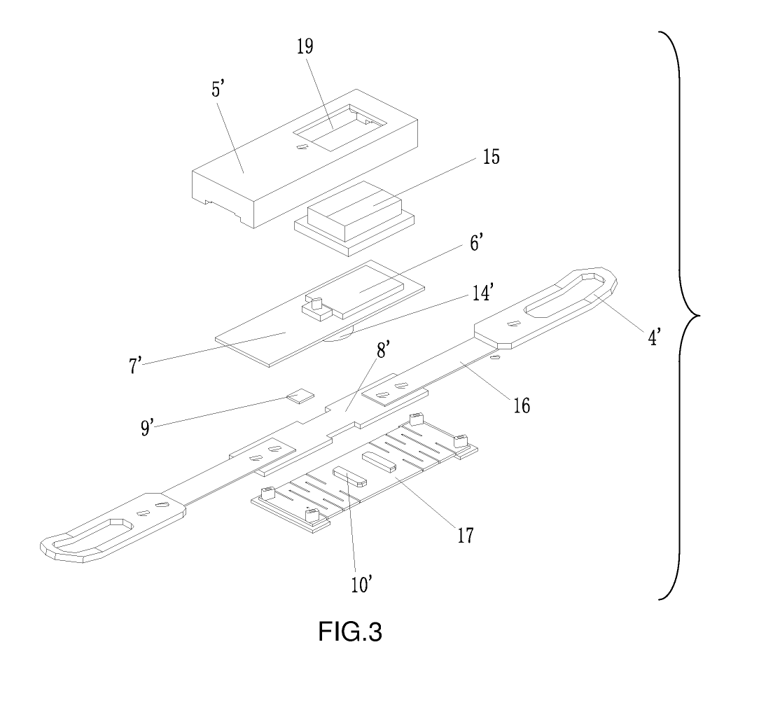

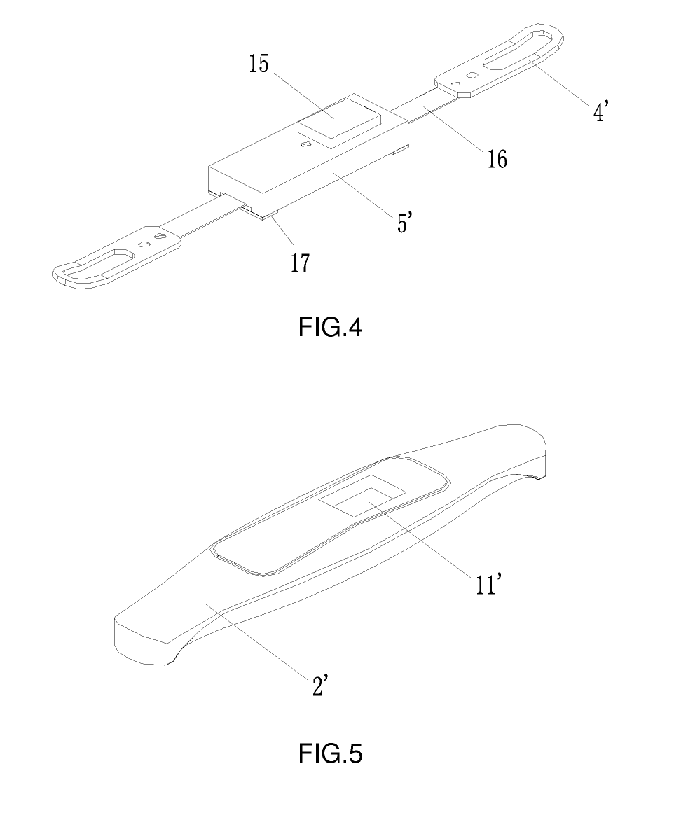

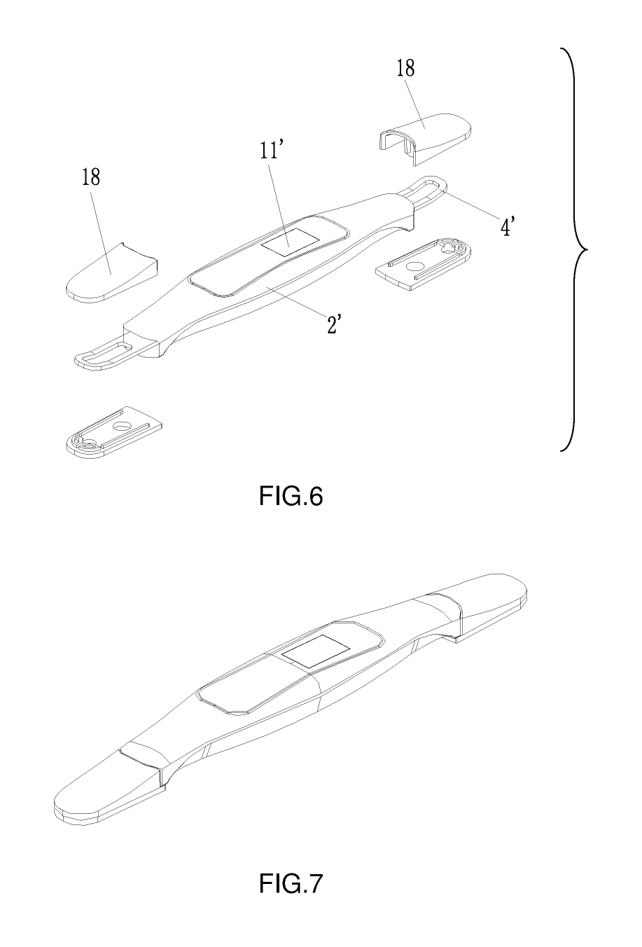

The present invention includes a handle seat 2′ and a connection 4′ that is connected between the handle seat and case body, the handle seat 2′ has a manganese steel sheet 8′ inside, a bend sensor 9′ is fixed at the top of the manganese steel sheet 8′, the bend sensor 9′ is connected to a PCB board 7′, the PCB board 7′ is connected to battery 14′ and display 6′ respectively. The both ends of the manganese steel sheet 8′ are connected with shrapnel 16 respectively, the connection 4′ is fixed in the end of shrapnel 16 respectively. The both ends of the connection 4′ connect with the case body through the handle seat 2′. The display 6′ is fixed in the display protecting frame 5′, and the upper surface of the display 6′ fixes a display protecting cover 15. The lower part of the display protecting frame 5′ is open, and has a hole 19 in the upper surface, the lower cover 17 encapsulates the manganese steel sheet 8′, bend sensor 9′, PCB board 7′ and display 6′ in the lower part of the display protecting frame 5′, and the display protecting cover 15 is through out the hole, as shown in FIGS. 3 and 4. The display 6′ is LCD display. The lower cover 17 is a plastic soft cover, and fixes a top holder 10′ in the upper surface. The lower part of the handle seat 2′ is open, its upper surface has holes 11, as shown in FIG. 5. When assembles, the both ends of the connection 4′ are through outside handle seat 2′, the upper and lower ends of the connection 4′ fix a handle cover 18, which encapsulates it as a whole and connects to the case body, as shown in FIGS. 6 and 7.

The principle of this example is the same as example one, it does not repeat here.

The above content is a further detail description about the present invention combining the preferred embodiments, the embodiments can't be considered that it is limited to the description. Various modifications and alterations of this invention will be apparent to those skilled in the art without departing from this invention, these should be within the scope of the present invention.

What is claimed is:

1. A case handle with weighing display, includes a handle seat and a connection that is connected between the handle seat and case body, which is characterized in that, the handle seat (2) has a manganese steel sheet (8) inside, a bend sensor (9) is fixed at the top of the manganese steel sheet (8), the bend sensor (9) is connected to a PCB board (7), the PCB board (7) is connected to battery (14) and display (6) respectively.

2. The case handle with weighing display according to claim 1, which is characterized in that, the handle seat (2) has a cavity in the upper part, and has a upper cover (1) above it, the upper cover (1) encapsulates the manganese steel sheet (8), bend sensor (9), PCB board (7), battery (14) and display (6) in the cavity of the upper part of the handle seat (2).

3. The case handle with weighing display according to claim 1, which is characterized in that, the connection (4) is in the cavity of the handle seat (2), the both ends of the connection (4) bents down through the handle seat (2) to connect with the case body.

4. The case handle with weighing display according to claim 1, which is characterized in that, the manganese steel sheet (8) has a top holder (10) in the lower part.

5. The case handle with weighing display according to claim 1 or 2, which is characterized in that, the handle seat (2) has a lower cover (3) in the lower part, the handle seat (2), lower cover (3) and top holder (10) have corresponding thread-holes, the screws (13) fixes the lower cover (3) and top holder (10) to the handle seat (2).

6. The case handle with weighing display according to claim 1, which is characterized in that, the display (6) is fixed in the display protecting frame (5).

7. The case handle with weighing display according to claim 1 or 6, which is characterized in that, the display (6) is LCD display.

8. The case handle with weighing display according to claim 2, which is characterized in that, the upper cover (1) has a hole (11) in the center, and the display protecting frame (5) is fixed in the hole.

9. The case handle with weighing display according to claim 3, which is characterized in that, the both ends of the connection (4) have thread-holes, the both ends of the manganese steel sheet (8) have corresponding thread-holes, the screws (12) make the connection (4) and the manganese steel sheet (8) permanently connect.

10. The case handle with weighing display according to claim 1, which is characterized in that, the blend sensor (9) is fixed between the connection (4) and the manganese steel sheet (8).

11. The case handle with weighing display according to claim 1, which is characterized in that, the both ends of the manganese steel sheet (8′) are connected with shrapnel (16) respectively, the connection (4′) is fixed in the end of shrapnel (16).

12. The case handle with weighing display according to claim 1, which is characterized in that, the display (6′) is fixed in the display protecting frame (5′).

13. The case handle with weighing display according to claim 1 or 12, which is characterized in that, the upper surface of the display (6′) fixes a display protecting cover (15).

14. The case handle with weighing display according to claim 13, which is characterized in that, the display (6′) is LCD display.

15. The case handle with weighing display according to claim 12, which is characterized in that, the lower part of the display protecting frame (5′) is open, and has a hole (19) in the upper surface, the lower cover (17) encapsulates the manganese steel sheet (8′), bend sensor (9′), PCB board (7′) and display (6′) in the lower part of the display protecting frame (5′), and the display protecting cover (15) is through out the hole (19).

16. The case handle with weighing display according to claim 15, which is characterized in that, the lower cover (17) is a plastic soft cover, and fixes a top holder (10′) in the upper surface.

17. The case handle with weighing display according to claim 11, which is characterized in that, the connection (4′) is connected with the case body through the both ends of the handle seat (2′).

18. The case handle with weighing display according to claim 17, which is characterized in that, the upper and lower ends of the connection (4′) fix a handle cover (18).
